(19) United States
(12) Patent Application Publication
(10) Pub. No.: US 2011/0055822 A1
(43) Pub. Date: Mar. 3, 2011

(54) METHOD FOR UPGRADING SOFTWARE OF GATEWAYS

(75) Inventor: CHIH-CHUN HSIEH, Tu-Cheng (TW)

(73) Assignee: HON HAI PRECISION INDUSTRY CO., LTD., Tu-Cheng (TW)

(21) Appl. No.: 12/629,121

(22) Filed: Dec. 2, 2009

(30) Foreign Application Priority Data
Aug. 25, 2009 (CN) 200910306040.8

(51) Int. Cl. G06F 9/44

(52) U.S. Cl. 717/173

(57) ABSTRACT

A computer-implemented method for upgrading software of a plurality of gateways, includes analyzing the status logs of a plurality of gateways to determine whether the gateways are in a normal status. The method further includes generating a device information file (INF) for each of the one or more gateways in a normal status, and triggering the gateways in the normal status to download the INF from the INF server. After downloading the INF, the one or more gateways in the normal status connect to the image server at a respective update time listed in the INF, and download a software update from the image server.

### BACKGROUND

1. Technical Field

Embodiments of the present disclosure relate to gateways, and especially to a method for upgrading software of gateways.

2. Description of Related Art

An operational flow for upgrading software in a gateway can include checking status of the gateway, setting an upgrade configuration, triggering the gateway to download corresponding to a device information file (INF), and confirming the upgrade. Each step in the upgrade process must, in many cases, be manually executed by an operator.

However, when multiple gateways are updated together, coordination of the process for all can present considerable difficulty, owing to varying schedules among the gateways.

### BRIEF DESCRIPTION OF THE DRAWINGS

FIG. 1 is a block diagram of one embodiment of an application environment of a gateway upgrade system utilizing a method for upgrading software of gateways as disclosed; and

FIG. 2 is a flowchart of one embodiment of a method for upgrading software of gateways as disclosed.

### DETAILED DESCRIPTION

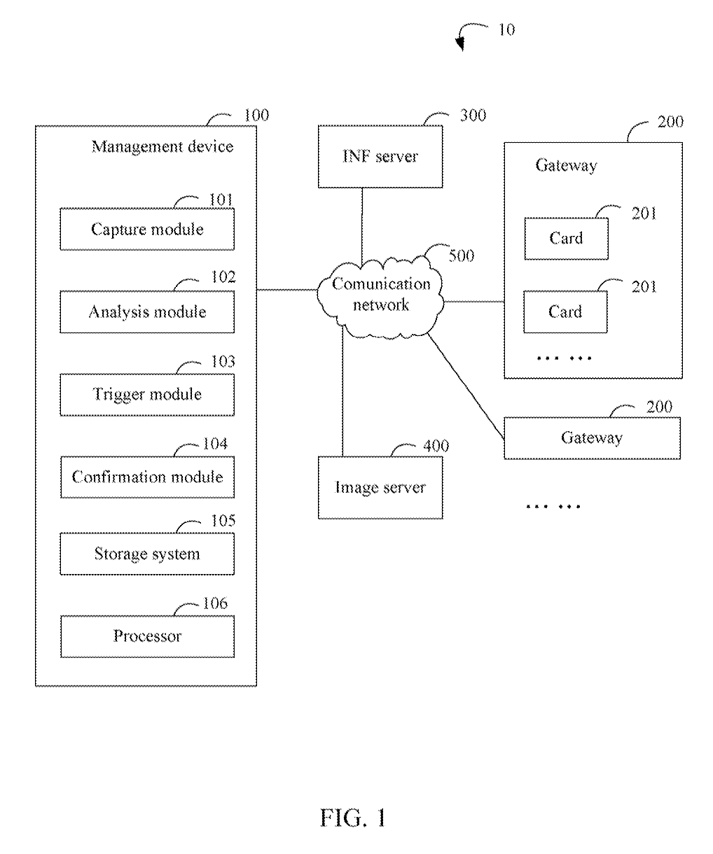

Referring to FIG. 1, a block diagram of one embodiment of an application environment of a gateway upgrade system 10 is disclosed. The gateway upgrade system 10 comprises a management device 100, a device information file (INF) server 300, an image server 400, and a plurality of gateways 200, connected by a communication network 500.

The gateway 200 generates a status log. In one embodiment, the gateway 200 may include a plurality of cards 201 including line cards, and management cards for managing the line cards. The status log comprises a status of each card 201, a current alarm count table, and other setting values. The gateway 200 is considered normal only if all the cards 201 are in the active or standby modes correctly, the alarm count is 0, and the other setting values are normal. In one embodiment, the alarm count is used to count errors of the gateway 200.

The management device 100, implementing management of the plurality of gateways 200, comprises a capture module 101, an analysis module 102, a trigger module 103, and a confirmation module 104. The capture module 101 communicates with the plurality of gateways 200, and acquires status logs thereof. The analysis module 102 is operable to analyze the status logs, to ascertain the status of the plurality of gateways 200. The trigger module 103 is operable to trigger the one or more gateways 200 to be in normal status to download an INF from the INF server 300. The confirmation module 104 is operable to discern whether all of the plurality of gateways 200 in normal status have completed the software upgrade. Each of the modules 101-104 may comprise one or more computerized codes that are stored in a storage system 105 of the management device 100 and operable to be executed by at least one processor 106.

The INF server 300 is connected to the one or more gateways 200 to be in normal status based on the analysis of the analysis module 102 of the management device 100, and generates an INF for each of the one or more gateways 200 to be in normal status. The INF comprises a media access control (MAC) address, and mapping addresses in the image server 400, of the one or more gateways 200 to be in normal status to locate the path to download software update in the imager server 400 easily, and further comprises an update time for the normal gateways 200 to update.

The image server 400 is operable to disseminate the software update for the plurality of gateways 200, where the plurality of gateways 200 are configured to download the software update automatically.

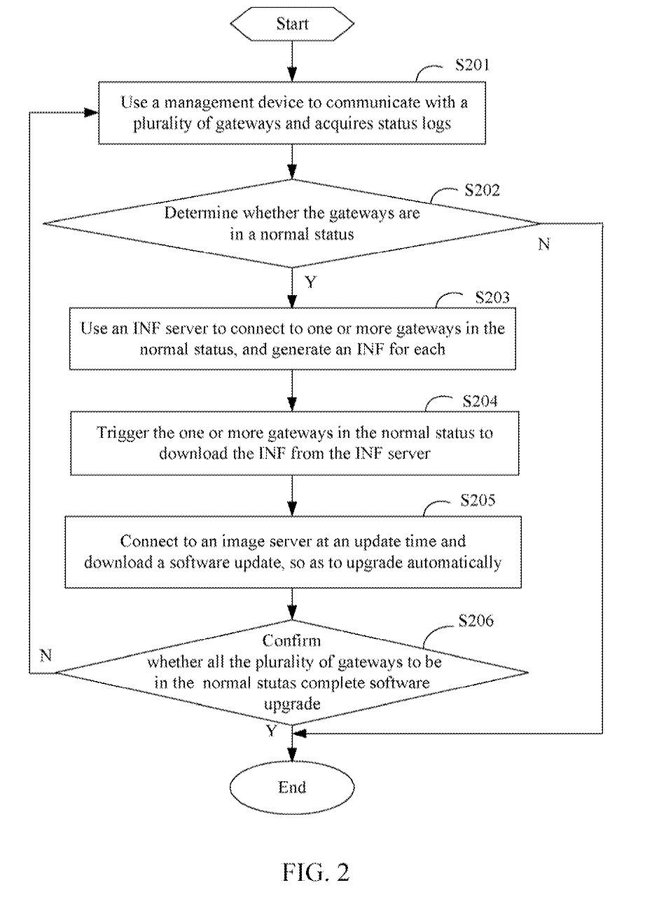

Referring to FIG. 2, a flowchart of an embodiment of a method for upgrading software of gateways 200 as disclosed, the method being applied in a gateway upgrade system 10 such as, for example, that shown in FIG. 1. In block S201, the capture module 101 of the management device 100 communicates with a plurality of gateways 200, and acquires status logs thereof. In one embodiment, each log comprises a status for the card 201 it represents, a current alarm count table, and other setting values.

In block S202, the analysis module 102 of the management device 100 analyzes the acquired status logs for the plurality of gateways 200 to determine which, if any, for the plurality of gateways 200 are in a normal status. In one embodiment, the gateway 200 is considered normal only if all the cards 201 in the gateway 200 are active and standby modes of the gateway 200 are normal, the alarm count is 0, and the other setting values are normal.

If the analysis module 102 determines that one or more gateways 200 are in abnormal status, the management device 100 stores information from the status logs and stops the software upgrade of the gateways 200 that are in abnormal status. If the analysis module 102 determines that any of the plurality of gateways 200 is in normal status, block S203 is implemented.

In block S203, the INF server 300 connects to the one or more gateways 200 deemed in normal status, and generates an INF for each. In one embodiment, the INF comprises both fixed and variable information. The fixed information comprises information that remains unchanged, such as gateway mapping address on the image server 400. The variable information refresh in real-time, and comprise, for example, update time, MAC address of the gateway 200, and others.

In block S204, the trigger module 103 of the management device 100 triggers the one or more gateways 200 in the normal status to download the INF from the INF server 300.

In block S205, the one or more gateways 200 in the normal status connect to the image server 400 at a respectively update time listed in the INF, and download a software update, so as to automatically update the software of the plurality of gateways. In one embodiment, the one or more gateways 200 in normal status connect to the image server 400 and download the upgrade software according to the MAC address and mapping address in the image server 400.

In block S206, the confirmation module 104 of the management device 100 confirms whether all of the plurality of gateways 200 in normal status finished have completed the software upgrade.

The process is complete for each gateway 200 in normal status that completes the software upgrade.

If any of the plurality of gateway 200 in normal status does not complete the software upgrade, block S201 is repeated.

The method for upgrading software of gateways 200 allows gateways 200 to upgrade automatically through the management device 100, reducing manpower and time requirements.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A computer-implemented method for upgrading software of a plurality of gateways, comprising:
at a management device, communicating with the plurality of gateways via a communication network, and acquiring status logs of the plurality of gateways;
analyzing the status logs to determine whether any of the plurality of gateways are in a normal status;
using a device information file (INF) server to connect to one or more gateways found to be in the normal status based on the analysis results, and generating a device information file (INF) file for each of the one or more gateways in the normal status, wherein the INF comprises an update time of each of the one or more gateways in the normal status; and
triggering the one or more gateways in the normal status to download the INF from the INF server;
wherein after finishing downloading the INF, the one or more gateways in the normal status connect to an image server at a respective update time listed in the INF, and download a software update from the image server, so as to automatically update the software of the plurality of gateways.

2. The method as claimed in claim 1, wherein the analysis module of the management device stops the software upgrade of any of the plurality of gateways determined to be in an abnormal status.

3. The method as claimed in claim 1, wherein the INF further comprises a media access control (MAC) address and mapping address in the image server for the gateway corresponding to the INF.

4. The method as claimed in claim 3, wherein each of the gateways connects to the image server according to the MAC address and the mapping address in the image server listed in the respective INF thereof.

5. The method as claimed in claim 1, further comprising the confirming module of the management device confirming whether all of the plurality of gateways in the normal status have completed the software upgrade.
